(19) United States
(12) Patent Application Publication
(10) Pub. No.: US 2005/0099640 A1
(43) Pub. Date: May 12, 2005

(54) Page data editor, component image display method in page data editor and program

(75) Inventors: Minoru Sawada, Kyoto (JP); Hiroyuki Segawa, Kyoto (JP); Shigehiro Hishiike, Kyoto (JP)

Correspondence Address: MCDERMOTT, WILL & EMERY, 600 13th Street, N.W., WASHINGTON, DC, 20005-3096, US

(73) Assignee: DAINIPPON SCREEN MFG. LTD., CO.

(21) Appl. No.: 10/971,148

(22) Filed: Oct. 25, 2004

(30) Foreign Application Priority Data
Nov. 7, 2003 (JP) JP2003-378019

(51) Int. Cl. H04N 1/52; H04N 1/56

(52) U.S. Cl. 358/1.9; 358/537; 358/536

(57) ABSTRACT

A page data editor capable of listing types of dot patterns assigned to component images arranged on a page respectively, collectively displaying component images to which a specific dot pattern is assigned and readily changing the dot pattern of a selected component image, a component image display method in a page data editor and a program are provided. The page data editor acquires dot patterns assigned to a plurality of component images respectively from page data and displays a list of the names thereof. The page data editor also creates a list associating the dot patterns and the component images with each other. When a certain dot pattern is specified on the basis of the displayed list, a display element discriminably displays the component images to which the dot pattern is assigned on the basis of the list.

### BACKGROUND OF THE INVENTION

1. Field of the Invention

The present invention relates to a page data editor for editing page data, and more particularly, it relates to a page data editor capable of readily confirming and setting the types and screen angles of dot patterns of component images arranged on a page, a component image display method in the page data editor and a program.

2. Description of the Background Art

In general, a designer creates page data by laying out on a page a plurality of types of component images such as characters, logotypes, images and illustrations, for example, for constituting printed matter with a computer, and provides the page data to prepress and printing steps. While the designer describes the page data in a page description language such as PostScript (trade name by Adobe Systems, U.S.A.) or PDF (portable document format), the data of this format cannot be employed for prepress and printing steps as such, and hence a raster image processor (hereinafter abbreviated as “RIP”) converts the page data to printing data of a format printable in a printer for printing the same.

The RIP executes rasterization through processes of:
1) analyzing the script of the page data described in the page description language and creating bitmap data of multivalued gradation expressing pages on the basis of results of the analysis; and
2) performing screening the created bitmap data for converting the same to binary bitmap data, i.e., converting the data expressing variable density images in continuous gradation to dot data expressing the variable density images with numbers and magnitudes of dots.

The contents of the screening for creating the dot data depend on the number of screen lines, shapes of dots and screen angles. In other words, the number of the screen lines, the shapes of the dots and the screen angles specify dot patterns in the dot data obtained by the screening. The dot data resulting from rasterization are transmitted to an output unit such as a plate recorder or a digital printer as printing data, for creating printed matter expressing pages with dots (refer to Japanese Patent Application Laying-Open Gazette No. 2002-142114).

In order to execute the screening, i.e., generation of dot data in the RIP, different dot patterns may be set for a plurality of component images laid out on a page respectively. This is referred to as “multi-screening”.

In order to perform multi-screening, dot patterns must be specified for the respective ones of the component images laid out on the page. In general, a page data editor reads the page data created by the designer in prepress and printing steps for assigning dot patterns to the component images laid out in the page data respectively thereby implementing a step of specifying a dot pattern every component image.

In general, however, there has been no method of collectively confirming the correspondence between the component images and the dot patterns as to which dot pattern is specified for which component image after assigning the dot patterns to the component images. In order to confirm this correspondence in collation of the page data, therefore, the component images on the page must be specified punctatim for checking the dot patterns therefor, disadvantageously leading to extra man-hours.

Further, layout data may be so set as to perform processing such as trapping or transparency on a certain component image, in order to prevent dropout in printing. In this case, screen angles for the component image must be changed from values set in specification of the dot pattern in consideration of another component image located under the same. However, no conventional page data editor has this function.

In addition, the designer may assign dot patterns to respective component images when creating page data by laying out the component images on a page. However, the computer employed by the designer for creating the page data is generally arranged separately from the RIP, and hence it may be impossible for the designer to previously confirm whether or not the RIP is capable of processing the dot patterns assigned to the component images. Therefore, it is necessary to confirm whether or not the dot patterns assigned by the designer are processible in the RIP in the prepress/printing steps and change the dot patterns to processible ones if the same are unprocessible. However, no conventional page data editor has this function.

### SUMMARY OF THE INVENTION

The present invention relates to a page data editor for editing page data.

According to the present invention, the page data editor for editing page data comprises a display element, an input element, a dot pattern acquisition element for acquiring dot patterns assigned to respective component images included in the page data by analyzing the script of the page data, a dot pattern lineup element for displaying a lineup of the dot patterns acquired by the dot pattern acquisition element on the display element, and a discriminative component image display element for performing prescribed discriminative display on all of corresponding component images to which an objective dot pattern is assigned in response to a selection of the objective dot pattern from the lineup made through the input element.

Thus, an operator can observe the types of the dot patterns assigned to the respective component images arranged on a page, for collectively displaying component images to which a specific dot pattern is assigned.

Accordingly, an object of the present invention is to provide a page data editor capable of listing the types of dot patterns assigned to respective component images arranged on a page.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the structure of a page data editing system, particularly a page data editor according to an embodiment of the present invention;

FIG. 2 is a flow chart for illustrating operations of the page data editor;

FIG. 3 illustrates a page data table expressing the structure of page data;

FIG. 4 illustrates a dot pattern list;

FIG. 5 illustrates a dot pattern name lineup area;

FIGS. 6A and 6B are diagrams for illustrating a state of first discriminative display on component images;

FIG. 7 illustrates a state of specifying one of the component images;

FIG. 8 is a flow chart for illustrating processing on the specified component image;

FIG. 9 illustrates a component image information table; and

FIG. 10 illustrates a dot pattern change menu.

### DESCRIPTION OF THE PREFERRED EMBODIMENTS

The best mode for carrying out the present invention is now described with reference to the drawings.

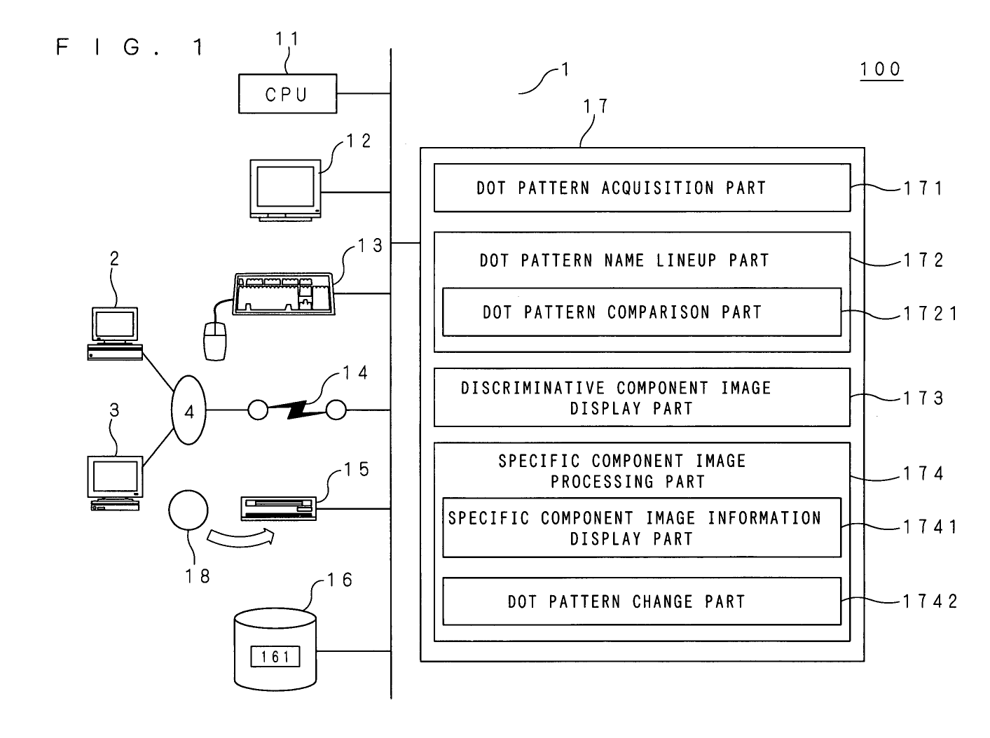

FIG. 1 illustrates the structure of a page data editing system 100 according to an embodiment of the present invention. In the page data editing system 100, a page data editor 1, formed by a generally used personal computer, is constituted of a CPU 11, a display part 12, an input part 13, a network interface 14, a media drive 15, a storage part 16 and a memory 17.

The CPU 11 controls the overall page data editor 1. In particular, the CPU 11 rums a program 161 recorded in a media disk 18 inserted into the media drive 15 through the memory 17, thereby implementing functions of the page data editor 1.

The page data editor 1 uses the display part 12 for displaying information necessary for editing page data. In particular, the display part 12 displays a lineup of dot patterns AP assigned to component images BZ respectively, component images BZ to which a certain dot pattern AP is assigned upon specification of this dot pattern AP, etc.

An operator uses the input part 13, constituted of a mouse, a keyboard etc., for inputting instructions in the page data editor 1.

The network interface 14 is employed for connecting the page data editor 1 with a network 4. The page data editor 1 receives page data PD from a terminal (designer terminal) 2 for the designer connected to the network 4 through the network interface 14. The dot patterns AP are assigned to the component images BZ comprised in the page data PD. The page data editor 1 further receives dot pattern information APJ from a raster image processor (hereinafter abbreviated as “RIP”) 3 through the network interface 14. The dot pattern information APJ is information as to processing of the dot patterns AP in the RIP 3. The page data editor 1 transmits the page data PD to the RIP 3 through the network interface 14 after confirming/editing the dot patterns AP. The page data editor 1 can also download a program implementing the functions thereof from a server (not shown).

The page data editor 1 uses the media drive 15 for reading the program 161 recorded in the media disk 18. The program 161 read through the media drive 15 implements the functions of the page data editor 1. The page data editor 1 also uses the media drive 15 for reading the media disk 18 storing the dot pattern information APJ.

The storage part 16 stores the program 161 read through the media drive 15. The storage part 16 also stores the page data PD and the dot pattern information APJ.

The memory 17 is a work area employed by the CPU 11 for running the program 161 stored in the storage part 16. The CPU 11 so runs the program 161 that the memory 17 implements functions of a dot pattern acquisition part 171, a dot pattern name lineup part 172, a discriminative component image display part 173 and a specific component image processing part 174.

The dot pattern acquisition part 171 acquires the dot patterns AP from the page data PD. The dot patterns AP are assigned to the component images BZ arranged on a page expressed by the page data PD. The designer terminal 2 or a dot pattern assignment part (not shown) of the page data editor 1 has already assigned the dot patterns AP to the component images BZ. The dot pattern acquisition part 171 analyzes the contents described in the page data PD, thereby acquiring and temporarily storing the dot patterns AP assigned to the component images BZ.

The dot pattern name lineup part 172 displays a lineup of the names of the dot patterns AP acquired by the dot pattern acquisition part 171 on the display part 12. This dot pattern name lineup part 172 reads the names of the dot patterns AP temporarily stored in the dot pattern acquisition part 171 and displays the lineup thereof on the display part 12.

The dot pattern name lineup part 172 comprises a dot pattern comparison part 1721. The dot pattern comparison part 1721 compares the dot patterns AP acquired by the dot pattern acquisition part 171 with the dot pattern information APJ received from the RIP 3. The dot pattern information APJ stores information related to processing of the dot patterns AP in the RIP 3, i.e., contents related to the dot patterns AP and screen angles available for multi-screening in the RIP 3. The dot pattern comparison part 1721 compares the dot patterns AP with the dot pattern information APJ for determining whether or not the dot patterns AP are processible in screening in the RIP 3.

The dot pattern name lineup part 172 displays the dot patterns AP determined as available for screening in the RIP 3 and those determined as unavailable for screening in the RIP 3 as a result of the comparison in the dot pattern comparison part 1721 in different colors. Thus, the operator can readily determine the dot patterns AP unprocessible in the RIP 3.

The discriminative component image display part 173 analyzes the script of the page data PD and discriminably displays component images BZ to which a certain dot pattern AP is assigned when displaying the page contents expressed by the page data PD on the display part 12. When the operator of the page data editor 1 selects the certain dot pattern AP from those in the lineup displayed on the display part 12 by operating the input part 13 in order to specify this dot pattern AP, the discriminative component image display part 173 retrieves the component images BZ to which the specified dot pattern AP is assigned. The discriminative component image display part 173 implements first discriminative display rendering the corresponding component images BZ readily discriminable from the remaining component images BZ. Thus, the operator can readily discriminate the component images BZ having the selected dot pattern AP from the remaining component images BZ on the display part 12. The discriminative component image display part 173 performs the first discriminative display on all component images BZ to which the same dot pattern AP is assigned. The discriminative component image display part 173 may perform the first discriminative display by any method such as highlighting, reversing or outlining, for example, so far as the operator can readily discriminate the objective component images BZ are from the remaining ones.

The specific component image processing part 174 further discriminably displays one of the component images BZ, subjected to the first discriminative display by the discriminative component image display part 173, selected by the operator. When the operator of the page data editor 1 specifies one of the component images BZ already subjected to the first discriminative display on the display part 12 by operating the input part 13, the specific component image processing part 174 performs second discriminative display for rendering the specified component image BZ discriminable on the display part 12. Thus, it follows that the operator has specified the objective component image BZ for processing described later. The specific component image processing part 174 may perform the second discriminative display by any method such as highlighting in gradation different from that of the remaining component images BZ subjected to the first discriminative display, reversing in different brightness or outlining in a different color, for example, so far as the operator can readily discriminate the objective component image BZ from the remaining component images BZ subjected to the first discriminative display in the discriminative component image display part 173.

The specific component image processing part 174 comprises a specific component image information display part 1741 and a dot pattern change part 1742 for processing on the component image BZ specified by the operator as the object of the processing.

The specific component image information display part 1741 acquires information related to the specified component image BZ by analyzing the script of the page data PD and displays the same on the display part 12. The information of the component image BZ displayed on the display part 12 includes trapping related to the component image BZ, setting of transparency, screen angles of the dot pattern AP assigned to the component image BZ etc.

In relation to the trapping, the display part 12 displays information related to a trapping graphic supplied to the component image BZ. The term “trapping” indicates processing of further supplying a graphic to either one or both of adjacent graphics having different colors in order to prevent the adjacent portions from dropout in printing. When the specified component image BZ is supplied with a trapping graphic, the specific component image information display part 1741 displays information related to the trapping graphic.

In relation to transparency, the display part 12 displays information related to a transparence attribute supplied to the component image BZ. The term “transparency” indicates setting for displaying no overlapped portion of a second component image BZ when overlapping first and second component images BZ with each other. In this case, the display part 12 displays the lower one of overlapping graphics transparently through the upper one. The specific component image information display part 1741 displays the information related to transparency as to the specified component image BZ as well as that subjected to setting of transparency with respect to the specified component image BZ.

In relation to the screen angles of the dot pattern AP, the display part 12 displays information related to the angles of arrangement of dots defined by the dot pattern AP. The dots are defined to be formed on paper with specific angles respectively so that no dots of respective color plates are overlapped on the same point of the paper and no moiré is formed by interference of the dots when performing multicolor printing of yellow, magenta, cyan and black, for example. The specific component image information display part 1741 displays information related to the screen angles in respective color plates set in response to the type of the dot pattern AP from the dot pattern AP assigned to the specified component image BZ.

The dot pattern change part 1742 changes the dot pattern AP assigned to the component image BZ specified by the operator. The dot pattern change part 1742 changes the assigned dot pattern AP when, for instance, it is proved that the dot pattern AP assigned to the component image BZ is unprocessible in the RIP 3 from the contents of the lineup displayed on the display part 12 or the operator determines that it is better to change the screen angles of a cyan plate (C plate) and a magenta plate (M plate) from the relation of color densities. The dot pattern change part 1742 the dot pattern AP assigned to the component image BZ itself to another dot pattern in response to an instruction for changing the dot pattern AP input by the operator by operating the input part 13. In this preferred embodiment, it is assumed that change of the dot pattern AP also includes change of the screen angles of the respective color plates in the dot pattern AP assigned to the component image BZ.

The dot pattern change part 1742 preferably changes the dot pattern AP through the dot pattern information APJ received from the RIP 3. In this case, the dot pattern change part 1742 can advantageously select the changed dot pattern AP from those available for the RIP 3.

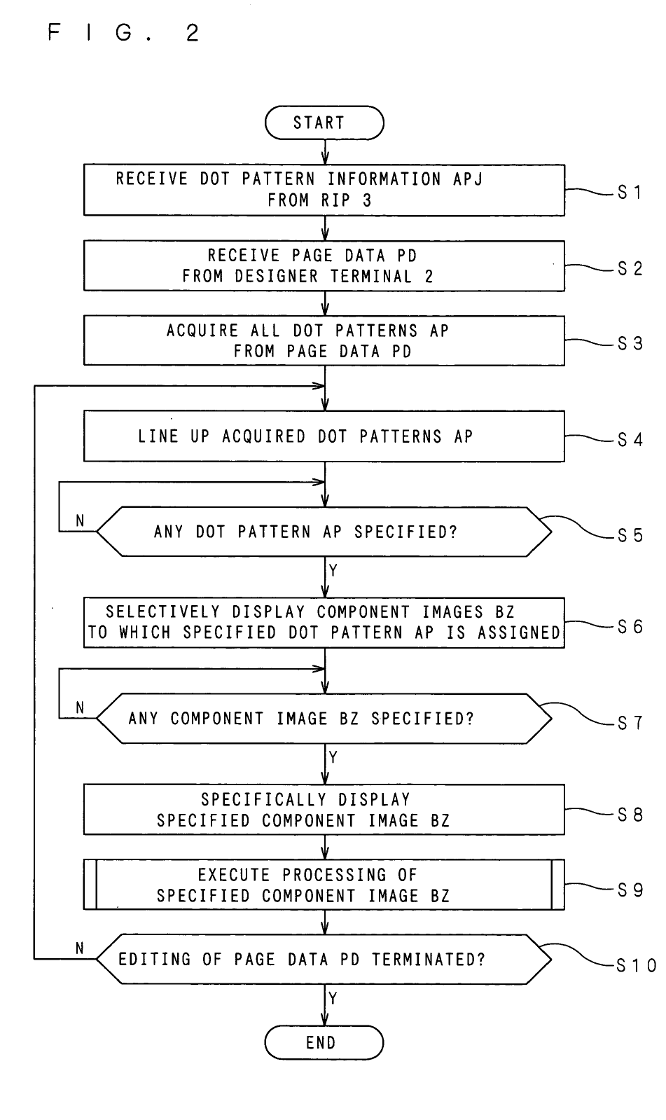

FIG. 2 is a flow chart for illustrating operations of the page data editing system 100, particularly the page data editor 1.

At a step S1, the page data editor 1 receives the dot pattern information APJ from the RIP 3. The page data editor 1 requests the RIP 3 connected therewith through the network 4 to transmit the dot pattern information APJ. The RIP 3 receiving this request transmits the dot pattern information APJ. The page data editor 1 stores the received dot pattern information APJ in the storage part 16 through the network interface 14.

Alternatively, the RIP 3 may read the dot pattern information APJ stored in the media disk 18 and store the same in the storage part 16.

At a step S2, the page data editor 1 receives the page data PD from the designer terminal 2. In the designer terminal 2, an editorial part (not shown) creates the page data PD. A transmission part (not shown) transmits the created page data PD to the page data editor 1. The page data editor 1 stores the received page data PD in the storage part 16 through the network interface 14.

The page data editor 1 may carry out the steps S1 and S2 in reverse order.

At a step S3, the dot pattern acquisition part 171 of the page data editor 1 analyzes the contents described in the page data PD for acquiring the dot patterns AP assigned to the component images BZ arranged on the page expressed by the page data PD respectively. A dot pattern assignment part (not shown) of the page data editor 1 or the designer terminal 2 has already assigned the dot patterns AP to the component images BZ.

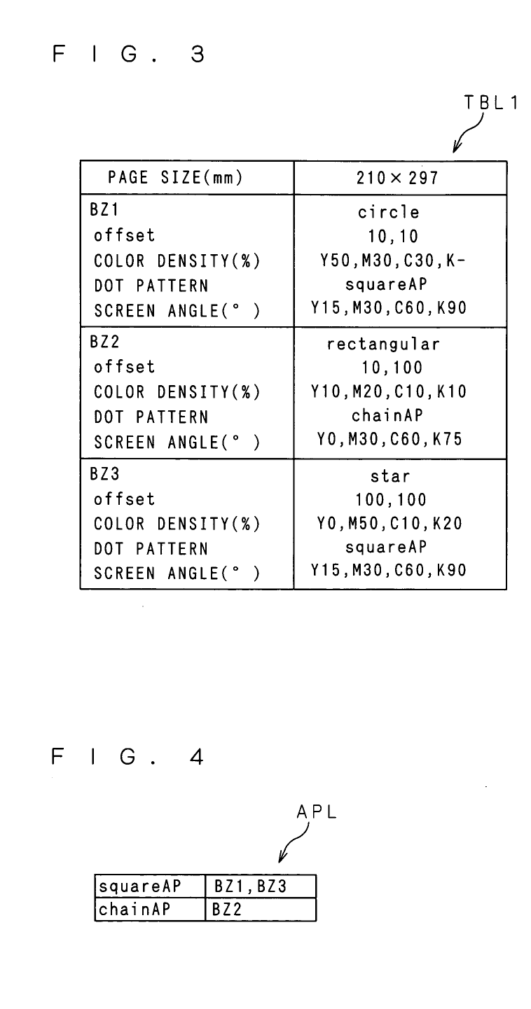

FIG. 3 illustrates a page data table TBL1 showing the structure of the page data PD. Component images BZ1, BZ2 and BZ3 are arranged in the page data PD having a page size of 210 by 297 (mm) in the structure shown in the page data table TBL1. The page data table TBL1 indicates that the component images BZ1, BZ2 and BZ3 are so arranged that offset values thereof are (10, 10), (10, 100) and (100, 100) with respect to the offset origin (0, 0) respectively. The page data table TBL1 shows the component image BZ1 as follows:

The component image BZ1 has a circular shape and YMCK color densities of “Y/50%, M/30%, C/30% and K/0%”. The name of the dot pattern AP assigned to the component image BZ1 is “squareAP”, and screen angles in the respective color plates are “Y/15°, M/30°, C/60° and K/90°”.

The page data table TBL1 shows similar contents also as to the component images BZ2 and BZ3.

The dot pattern acquisition part 171 analyzes the script of the page data PD having the contents shown in the page data table TBL1, for example, thereby acquiring the dot patterns AP of the types assigned to the component images BZ1, BZ2 and BZ3 respectively. FIG. 4 shows a dot pattern list APL of the dot patterns AP acquired by the dot pattern acquisition part 171. It is understood from the dot pattern list APL shown in FIG. 4 that the dot pattern acquisition part 171 acquires two types of dot patterns AP, i.e., “squareAP” and “chainAP”, from the page data PD shown in the page data table TBL1. Further, the dot pattern list APL associates the component images BZ1, BZ2 and BZ3 to which the dot patterns AP are assigned with the names of the dot patterns AP respectively. The dot pattern acquisition part 171 temporarily stores the dot pattern list APL for processing described later.

While the three component images BZ1, BZ2 and BZ3 are arranged in the page data PD and the two types of dot patterns AP are assigned thereto in the above description, the numbers of the component images BZ and the dot patterns AP are not restricted to these.

Referring again to FIG. 2, the dot pattern name lineup part 172 refers to the dot pattern list APL and displays a lineup of the dot patterns AP assigned to the component images BZ on the display part 12 at a step S4. Further, the dot pattern comparison part 1721 compares the dot pattern list APL with the dot pattern information APJ received from the RIP 3. The dot pattern name lineup part 172 displays dot patterns AP determined as unprocessible in the RIP 3 as a result of this comparison in a color different from those of the remaining dot patterns AP, for example, to be discriminable from the remaining dot patterns AP.

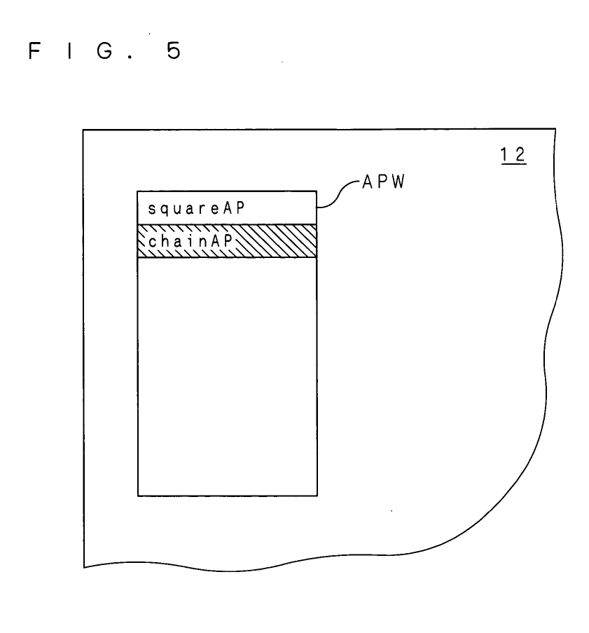

FIG. 5 illustrates a dot pattern name lineup area APW displayed on the display part 12 through the dot pattern name lineup part 172. The dot pattern name lineup part 172 refers to the dot pattern list APL and displays the dot pattern name lineup area APW on the display part 12. Referring to FIG. 5, the dot pattern name lineup area APW displays a lineup of the names “squareAP” and “chainAP” of the dot patterns AP acquired from the page data PD having the contents shown on the page data table TBL1.

The dot pattern name lineup area APW displays the name of the dot pattern AP unprocessible in the RIP 3 in a color different from those of processible ones. While the dot pattern name lineup area APW displays the name “chainAP” of the dot pattern AP unprocessible in the RIP 3 in a different color, FIG. 5 shows the name “chainAP” of the unprocessible dot pattern AP in hatching for convenience of illustration.

Referring again to FIG. 2, the page data editor 1 enters the wait state until the operator selects any of the dot patterns AP from the lineup displayed on the dot pattern name lineup area APW. When the operator selects any dot pattern AP by operating the input part 13, the page data editor 1 shifts to a step S6.

At the step S6, the discriminative component image display part 173 performs the first discriminative display on component images BZ to which a dot pattern AP specified by the operator is assigned. When the operator selects the name of any dot pattern AP, the discriminative component image display part 173 refers to the dot pattern list APL for acquiring the dot pattern AP having the name and retrieving the component images BZ to which the dot pattern AP is assigned. The discriminative component image display part 173 performs the first discriminative display on the display part 12 as to the corresponding component images BZ. The display part 12 implements a state of selecting the component images BZ corresponding to the dot pattern AP specified by the operator through the first discriminative display.

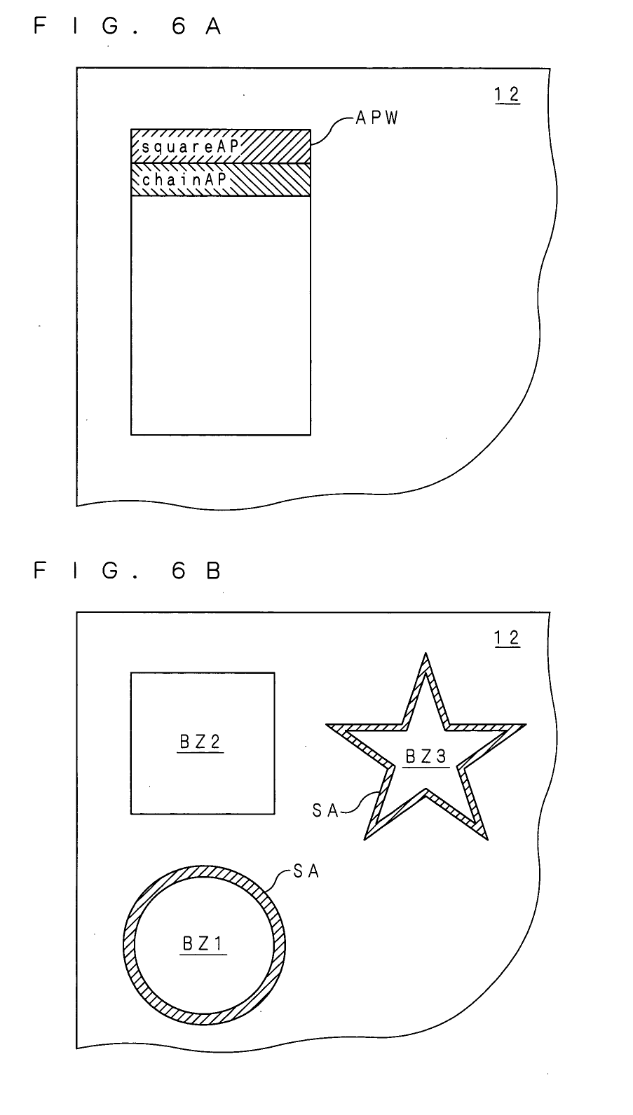

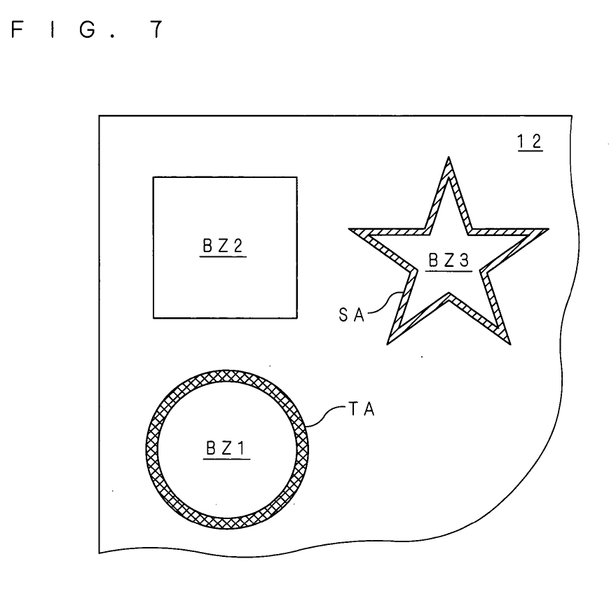

FIGS. 6A and 6B are diagrams for illustrating the first discriminative display made by the discriminative component image display part 173 on the component images BZ. FIG. 6A shows a state where the operator selects the dot pattern AP of the name “squareAP” on the dot pattern name lineup area APW. In this case, the discriminative component image display part 173 refers to the dot pattern list APL for retrieving the component images BZ to which the dot pattern AP having the name “squareAP” is assigned. In the case of the page data PD having the contents shown in the page data table TBL1, the component images BZ1 and BZ3 correspond thereto. Thus, the discriminative component image display part 173 performs the first discriminative display as to the component images BZ1 and BZ3. Referring to FIG. 6B, the discriminative component image display part 173 displays the component images BZ1 and BZ3 with discriminative display areas SA on the outer edges of the graphics expressed by the component images BZ1 and BZ3 respectively on the display part 12.

In other words, the discriminative component image display part 173 performs the first discriminative display as to the component images BZ1 and BZ3 to which the dot pattern AP is assigned simply when the operator of the page data editor 1 selects any of the names of the dot patterns AP from the lineup displayed on the display part 12. Thus, the operator can so collectively confirm the dot patterns AP specified as to the displayed page and the dot pattern AP specified for the component images BZ that he/she may not specify the component images BZ on the page punctatim for inspecting the dot patterns AP when collating the page data PD but this contributes to reduction of the man-hours.

The discriminative component image display part 173 may alternatively perform the first discriminative display on the component images BZ by a method other than that described above.

Referring again to FIG. 2, the page data editor 1 enters the wait state until the operator selects either one of the component images BZ subjected to the first discriminative display through the specific component image processing part 174 at a step S7. When the operator selects either one of the component images BZ by operating the input part 13, the page data editor 1 shifts to a step S8.

At the step S8, the specific component image processing part 174 performs second discriminative display as to the component image BZ specified by the operator. When the operator selects either one of the component images BZ subjected to the first discriminative display, the specific component image processing part 174 performs second discriminative display as to the selected component image BZ. Thus, it follows that the operator has specified a single component image BZ subjected to processing described later, and it also follows that the display part 12 discriminably displays this component image BZ.

FIG. 7 shows the specific component image processing part 174 performing the second discriminative display, i.e., specifying a certain component image BZ as the object of the processing described later at the step S8. When the operator selects the certain component image BZ from those subjected to the first discriminative display on the display part 12 by operating the input part 13, the specific component image processing part 174 performs the second discriminative display on this component image BZ. Referring to FIG. 7, the operator has selected the component image BZ1 as the object of the second discriminative display from the component images BZ1 and BZ3 shown in FIG. 6. FIG. 7 shows the display part 12 displaying the specified component image BZ1 with a specific display area TA on the outer edge of the graphic expressed by the same.

Referring again to FIG. 2, the page data editor 1 executes processing on the component image BZ specified through the specific component image processing part 174 at a step S9.

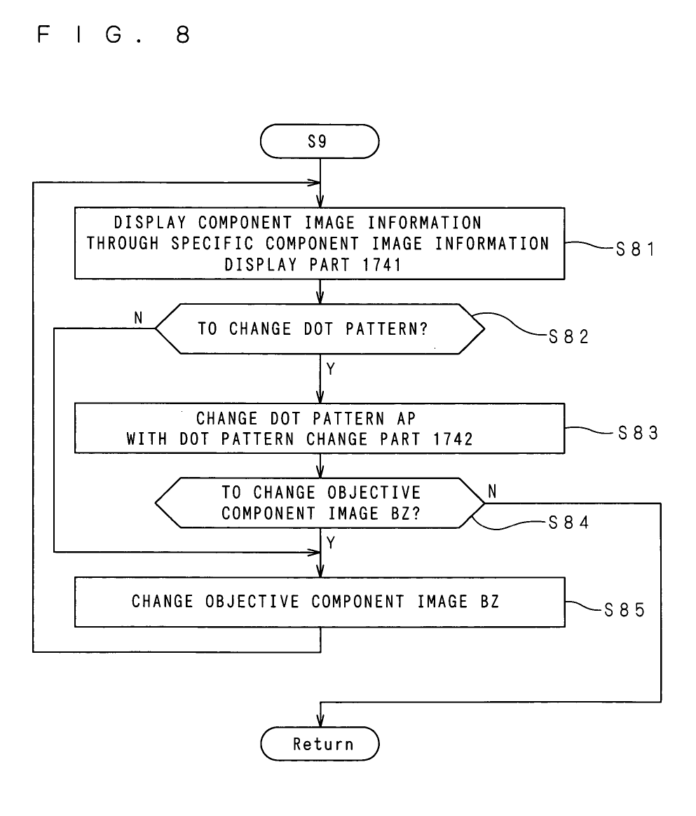

FIG. 8 is a flow chart for illustrating the processing at the step S9. At a step S81, the specific component image information display part 1741 displays component image information related to the component image BZ specified at the step S8 on the display part 12.

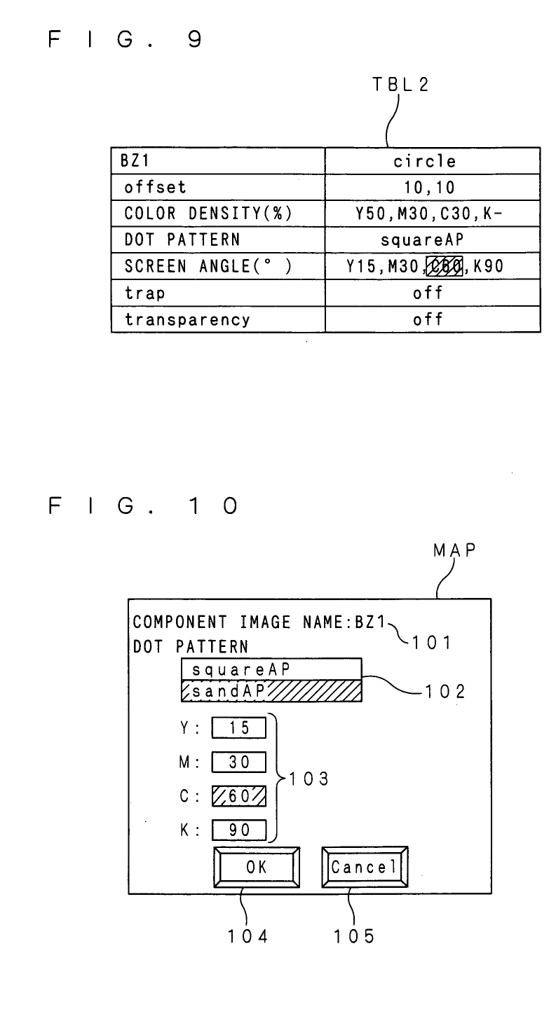

FIG. 9 shows a component image information table TBL2 showing the component image information displayed on the display part 12. The specific component image information display part 1741 acquires the component image information related to the component image BZ specified at the step S8 by analyzing the contents described in the page data PD and displays the same on the display part 12. FIG. 9 shows the component image information table TBL2 for the component image BZ1 shown in FIG. 7 specified as the object. In this case, it follows that the specific component image information display part 1741 analyzes the script of the page data PD having the contents shown in the page data table TBL1. As shown in FIG. 9, the component image information table TBL2 indicates the name of the component image BZ1, the offset value (10, 10), the YMCK color densities “Y/50%, M/30%, C/30% and K/0%”, the name “squareAP” of the assigned dot pattern AP, the screen angles “Y/15°, M/30°, C/60° and K/90°” in the respective plates and no setting of trapping and transparency. The component image information table TBL2 highlights only the screen angle “C→60″”, in order to indicate that no screen angle of 60° is present in the dot pattern AP assigned to the component image BZ1 despite the screen angle setting with respect to the C plate.

At a step S82, the operator confirms the component image information displayed on the display part 12 at the step S81, for determining requirement/nonrequirement of change of the dot pattern AP assigned to the component image BZ. When the operator determines that no change is necessary, the page data editor 1 shifts to a step S85. When the operator determines that change is necessary, on the other hand, the page data editor 1 shifts to a step S83.

At the step S83, the dot pattern change part 1742 performs change processing on the component image BZ1 determined as requiring the change. It is assumed here that the dot pattern change part 1742 changes the dot pattern AP assigned to the component image BZ1 or any screen angle in particular, and redundant description is omitted as to change of other items. The dot pattern change part 1742 changes the dot pattern AP of the component image BZ1 according to an instruction from the operator.

FIG. 10 shows a dot pattern change menu MAP displayed on the display part 12 through the dot pattern change part 1742 for changing the dot pattern AP assigned to the component image BZ1 or the screen angle. The dot pattern change menu MAP comprises a component image name display field 101, a dot pattern selection field 102, a screen angle specification field 103, an OK button 104 and a cancel button 105.

The component image name display field 101 displays the name of the component image BZ1 specified through the specific component image processing part 174.

The dot pattern selection field 102 is comprised for letting the operator select a desired dot pattern AP when changing the dot pattern AP assigned to the component image BZ1. The dot pattern change part 1742 refers to the dot pattern information APJ received from the RIP 3 for displaying the names of the dot patterns AP processible in the RIP 3. The operator selects one from the displayed names of the dot patterns AP by operating the input part 13. The dot pattern change part 1742 changes the dot pattern AP assigned to the component image BZ1 to the selected dot pattern AP.

The screen angle specification field 103 is comprised for changing the screen angle in any of the color plates. As shown in FIG. 10, the operator can input screen angles in the screen angle specification field 103 as to the Y, M, C and K color plates for printing the component image BZ1 respectively. The screen angle specification field 103 first displays the screen angles previously set for the component image BZ1. The operator can change the screen angle as to any desired plate by operating the input part 13 for deleting the initial screen angle and newly inputting the desired screen angle.

The dot pattern change menu MAP displays the screen angle for the C plate differently from the remaining screen angles, for indicating that the screen angle 60° specified for the C plate is unusable in the assigned dot pattern AP.

When satisfied with the contents input in the dot pattern change menu MAP, the operator presses the OK button 104. When the operator presses the OK button 104, the dot pattern change part 1742 changes the dot pattern AP assigned to the component image BZ1 or the screen angle according to the contents input in the dot pattern change menu MAP. At this time, the dot pattern change part 1742 stops displaying the dot pattern change menu MAP. When the operator presses the cancel button 105 in order to stop the change, the dot pattern change part 1742 stops displaying the dot pattern change menu MAP.

Referring again to FIG. 8, the operator determines whether or not to change the dot pattern AP as to another component image BZ, i.e., whether or not to objectify the other component image BZ for the processing in the specific component image processing part 174 at a step S84.

When the operator determines to objectify the other component image BZ, the page data editor 1 shifts to the step S85. The operator operates the input part 13 for selecting the component image BZ not subjected to the second discriminative display from the component images BZ subjected to the first discriminative display on the display part 12. In this case, the operator may directly specify the component image BZ displayed on the display part 12 by operating the input part 13, or the display part 12 may display a menu screen for selecting the component image BZ. Further, the operator may select the component image BZ in desired order or along the order of creation of the component images BZ. When the operator newly selects the component image BZ, the page data editor 1 returns to the step S81.

When the operator does not newly select the component image BZ, the page data editor 1 returns to a step S10 of the flow chart shown in FIG. 2.

At the step S10 shown in FIG. 2, the operator determines whether or not to terminate the editing on the page data PD. When the operator determines not to terminate the editing, the page data editor 1 returns to the step S4 for repeating the processing on the dot patterns AP described above. When the operator determines to terminate the editing, on the other hand, the page data editor 1 stores the edited page data PD in the storage part 16.

Thus, the page data editor 1 shown in FIG. 1 so operates along the flow chart shown in FIG. 2 that the operator thereof can observe the types of the dot patterns specified for the component images BZ arranged on the page respectively and collectively display the component images BZ to which the specific dot pattern AP is assigned. Further, he/she can readily select the displayed component images BZ and confirm the information related thereto. In addition, he/she can readily change the dot pattern AP assigned to the component images BZ.

[Modifications]

While the operator selects the certain component image BZ for displaying the component image information and changes the dot pattern AP assigned to the selected component image BZ or the screen angle separately in the above description, the page data editor 1 may alternatively parallelly carry out the steps S81 and S83 shown in FIG. 8 so that the operator can display the component image information and change the dot pattern AP or the screen angle at the same time.

The page data editor 1 may be integrated with the design terminal 2. In this case, the page data editor 1 requires no process of transferring the page data PD.

Alternatively, the page data editor 1 and the RIP 3 may be integrated with each other. In this case, the page data editor 1 requires no process of transferring the dot pattern information APJ.

Further alternatively, the page data editor 1 may be integrated with the design terminal 2 and the RIP 3.

In addition, the page data editor 1, processing the three types of dot patterns AP named “square”, “chain” and “sand” in the above description, may alternatively process other types of dot patterns AP. Further, the present invention is applicable to both of AM and FM dots.

While the invention has been shown and described in detail, the foregoing description is in all aspects illustrative and not restrictive. It is therefore understood that numerous modifications and variations can be devised without departing from the scope of the invention.

1. A page data editor for editing page data, comprising:
a display element;
an input element;
a dot pattern acquisition element for acquiring dot patterns assigned to respective component images included in said page data by analyzing the script of said page data;
a dot pattern lineup element for displaying a lineup of said dot patterns acquired by said dot pattern acquisition element on said display element; and
a discriminative component image display element for performing prescribed discriminative display on all of corresponding component images to which an objective dot pattern is assigned in response to a selection of said objective dot pattern from said lineup made through said input element.

2. The page data editor according to claim 1, further comprising a specific component image information display element for acquiring component image information of a specified component image and displaying said component image information on said display element in response to a selection of said specified component image from said corresponding component images made through said input element.

3. The page data editor according to claim 2, wherein
said component image information is at least one of trapping as to said specified component image, transparency and information related to a screen angle of said objective dot pattern assigned to said specified component image.

4. The page data editor according to claim 2, further comprising a dot pattern change element for changing said objective dot pattern assigned to said specified component image.

5. The page data editor according to claim 1, wherein
said dot pattern lineup element displays the name of any of said dot patterns unavailable in a raster image processor for performing said raster image processing on said page data in a color different from that for remaining said dot patterns.

6. A component image display method in a page data editor for editing page data, comprising steps of:
a) acquiring dot patterns assigned to respective component images included in said page data by analyzing the script of said page data;
b) displaying a lineup of said dot patterns acquired in said step a) on a display element of said page data editor;
c) making an operator of said page data editor select an objective dot pattern from said lineup through an input element of said page data editor; and
d) performing prescribed discriminative display on all of corresponding component images to which said objective dot pattern is assigned in response to a selection in said step c).

7. The component image display method in a page data editor according to claim 6, further comprising steps of:
e) making said operator of said page data editor select a specified component image from said corresponding component images through said input element; and
f) acquiring component image information of said specified component image and displaying said component image information on said display element in response to a selection in said step e).

8. A program, when executed by a computer, for causing said computer to function as a page data editor for editing page data, said page data editor comprising:
a display element;
an input element;
a dot pattern acquisition element for acquiring dot patterns assigned to respective component images included in said page data by analyzing the script of said page data;
a dot pattern lineup element for displaying a lineup of said dot patterns acquired by said dot pattern acquisition element on said display element; and
a discriminative component image display element for performing prescribed discriminative display on all of corresponding component images to which an objective dot pattern is assigned in response to a selection of said objective dot pattern from said lineup made through said input element.
